(19) United States
(12) Patent Application Publication
(10) Pub. No.: US 2014/0323608 A1
(43) Pub. Date: Oct. 30, 2014

(54) POLYMER DISPERSIONS

(71) Applicants: Christoph Deller, Mainz (DE); Ulrich Desor, Idstein (DE); Marc Ratering, Ulft (NL); Argiri Tsami-Schulte, Kelkheim (DE)

(72) Inventors: Christoph Deller, Mainz (DE); Ulrich Desor, Idstein (DE); Marc Ratering, Ulft (NL); Argiri Tsami-Schulte, Kelkheim (DE)

(73) Assignee: CELANESE EMULSIONS GmbH, Sulzbach (DE)

(21) Appl. No.: 14/364,127

(22) PCT Filed: Dec. 15, 2011
(86) PCT No.: PCT/IB2011/003233

§ 371 Date: Jun. 11, 2014

(51) Int. Cl. C09D 5/14

(52) U.S. Cl. CPC C09D 5/14
USPC 523/122

(57) ABSTRACT

A polymer dispersion comprises particles of a polymer composition formed at least partially by emulsion polymerization of first and second, simultaneously added, substantially styrene-free monomer feeds in the presence of an initiator in a reaction zone. The first monomer feed comprises monomers selected to produce a copolymer having a glass transition temperature less than or equal to about −10° C., while the second monomer feed comprises monomers selected to produce a copolymer having a glass transition temperature greater than or equal to about 50° C. The relative rate of addition of the first and second monomer feeds into the reaction zone is continuously changed during at least part of the emulsion polymerization and the rate of addition of the initiator is changed step-wise at least once during the addition of the first and second monomer feeds.

### CROSS-REFERENCE TO RELATED APPLICATIONS

The present Application is a U.S. National Phase of PCT/IB2011/003233 filed on Dec. 15, 2011. The disclosure of the PCT Application is hereby incorporated by reference into the present Application.

### FIELD

The present invention relates to polymer dispersions useful as binders for coating compositions, such as high gloss trim paints, lacquers and varnishes.

### BACKGROUND

Polymer dispersions useful as binders for coating compositions, such as high gloss trim paints, have to comply with increasingly stringent requirements. Traditionally, dispersions used for these applications have been produced by emulsion polymerization processes that employ ammonia as a neutralization medium. However, this is now considered undesirable because ammonia causes a pungent smell when the coating composition is applied to a surface. Similarly, styrene-based monomers have been extensively used in the production of polymeric binders since they tend to increase the gloss of the resulting coatings because of their high refractive index and since they produce polymers with good block resistance. However, concerns about the adverse health effects of styrene-based polymers have led to increased interest in styrene-free dispersions. Additionally, manufacturers have increasingly sought to minimize or eliminate volatile organic compounds (VOCs) in emulsions due to their toxicity and flammability. (Directive 2004/42/CE of the European Parliament and The Council of The European Union). Thus, to avoid the need to include coalescent agents (since these are known to be the main contributors to VOCs in coating applications), the base polymer should have a minimum film forming temperature (MFFT) lower than 10° C., preferably lower than 5° C.

There is therefore a need to develop a styrene-free and preferably ammonia-free polymer dispersion which has an (MFFT) lower than 10° C., preferably lower than 5° C., and which produces coatings with equivalent gloss and block resistance as existing styrene-based dispersions without the use of coalescent agents. In accordance with the invention, an acrylic based polymer emulsion meeting at least some of these requirements has been produced by control of the morphology and chemistry of the polymer particles.

U.S. Pat. No. 6,759,490 to Gerst et al. (“Gerst”) discloses a process for preparing an aqueous polymer dispersion of a copolymer of at least two different monomers by free-radical aqueous emulsion polymerization of the monomers in the presence of at least one initiator, at least 80% of the monomers and at least 75% of the initiator being supplied continuously to the polymerization reaction during its course, which comprises changing the rate at which the initiator is supplied to the polymerization reaction a number of times, or continuously, during the polymerization reaction. According to Gerst, changing the rate at which the initiator is supplied to the polymerization reaction leads to a broader distribution of molecular weight and an increased polydispersity (M_{w}/Mₙ) of the obtained polymers, where M_{w} refers to the weight average molecular weight, and Mₙ refers to the number average molecular weight. However, the polymer dispersions of Gerst are intended for use in pressure sensitive adhesives and is focused on polymerizations where at least 60% by weight of the monomers for polymerization are hydrophobic and whose homopolymer has a glass transition temperature less than or equal to 0 C. Additionally, all the examples of Gerst employ styrene monomers.

U.S. Pat. No. 5,756,573 to Trumbo et al. (“Trumbo”) discloses a seed polymerized latex polymer having a gradient polymer morphology surrounding a latex seed core. The polymerization process comprises introducing latex seed particles having a number average particle size of about 20 to about 60 nanometers, and introducing a first monomer feed composition and a second monomer feed composition simultaneously to an emulsion polymerization reaction zone. The first monomer feed composition and the second monomer feed composition each have at least one polymerizable reactant wherein a polymer of the at least one polymerizable reactant of the first monomer feed composition has a glass transition temperature T_{g}1 differing from a glass transition temperature T_{g}2 of a polymer of the at least one polymerizable reactant of the second monomer feed composition, preferably by greater than 50° C. The first and second monomer feed compositions are introduced at different feed rates so as to continuously vary the concentration ratio of the first monomer feed composition to the second monomer feed composition as the first and second monomer feed components are simultaneously introduced to the emulsion polymerization reaction zone to result in a seed polymerized latex polymer having a number average particle size less than about 100 nanometers. The latex polymer of Trumbo is said to be useful in the production of wood coatings having excellent print resistance and a high gloss finish. In addition to the complexity involved in preparing a latex seed particle, the latex seed particles employed in Trumbo are preferably composed of polystyrene.

U.S. Pat. No. 7,173,083 to Scheerder et al. (“Scheerder”) discloses an aqueous composition comprising components: (A) 50 to 99 wt. % of a vinyl polymer(s) having a gradient polymeric morphology; and (B) 1 to 50 wt. % of at least one polymer not having a gradient polymeric morphology, wherein components (A) and (B) add up to 100%. Scheerder discloses that a gradient polymeric morphology may be obtained by simultaneously introducing a first monomer feed and a different second monomer feed into a reactor where the rate of introduction of the first monomer feed varies with respect to the rate of introduction of the second monomer feed. The monomer feeds used to prepare the polymer with a gradient polymeric morphology usually differ with respect to, for example, glass transition temperature (Tg), monomer functionality (for example the use of crosslinking, acid functional or adhesion promoting monomers), hydrophilicity, refractive index, molecular weight or simply a variation in the concentration of the respective monomers in each monomer feed. Scheerder discloses styrene and derivatives thereof as a suitable vinyl monomer for forming vinyl polymer(s) with gradient polymer morphology, as well as the use of ammonia to neutralize the emulsion.

U.S. Pat. No. 6,617,389 to Delaunoit et al. (“Delaunoit) discloses an aqueous polymer dispersion for use in water based glossy lacquers. The polymer dispersion is formed from monomer compositions A and B, wherein the difference of the T_{g} of A and B after monomer polymerization is at least 60° C. and with the highest of such T_{g} being at least 40° C. Delaunoit discloses styrene and derivatives thereof as suitable monomers, as well as neutralization of the obtained dispersion using ammonia. Delaunoit's claims prescribe the incorporation of nitrogenous, adhesion promoting copolymerisable monomer as an essential component to obtain wet adhesion. The claims also describe the use of a power feed method, wherein the monomer composition A, which is added to the reactor, is continually being replenished by monomer composition B. This requires continuous stiffing the tank containing monomer composition A, complicating the process.

U.S. Pat. No. 3,804,881 to Bassett et al. (“Bassett”) generally discloses that non-uniform copolymers can be produced by continuously introducing at least one primary polymerizable feed composition to a polymerization zone, which is continually varying in compositional content of the reactants therein, while simultaneously adding at least one different secondary polymerizable feed composition, so as to continually change the compositional content of the reactants. Bassett discloses styrene and derivatives thereof as suitable polymerizable reactants. Additionally the power feed process described by the reference is not efficient from a production standpoint.

DE 10041680 to Porzio et. al. (“Porzio”) discloses an aqueous polymer dispersion prepared by radical-initiated aqueous emulsion polymerization of monomer mixtures (M1, M2) added according to a specific feed procedure. Polymerization is performed in a vessel fed with a monomer stream (m) formed from partial streams, m1 and/or m2, of M1 and M2, respectively, and during the process the proportion of m2 in m increases. At the start of feeding, m comprises at least 90 weight percent M1 but at the end it contains at least 90 weight percent M2. When used alone, M1 produces a polymer of glass transition temp (Tg1) not over 50° C. while M2, alone, produces a polymer with similar temperature (Tg2) over 50° C., with at least a 10° C. difference between Tg1 and Tg2. The ratio of total amounts of M1 and M2 is 20:80 to 60:40. However, the power feed process used by the reference is not efficient from a production standpoint and all the examples in the reference have fairly high MFFT values (>25° C.). Further, the reference does not discuss neutralization of the dispersions.

### SUMMARY

In one aspect, the invention resides in a polymer dispersion comprising particles of a polymer composition formed at least partially by emulsion polymerization of at least first and second, simultaneously added, substantially styrene-free, monomer feeds in the presence of an initiator in a reaction zone, wherein the first monomer feed comprises monomers selected to produce a copolymer having a glass transition temperature less than or equal to about −10° C. and the second monomer feed comprises monomers selected to produce a copolymer having a glass transition temperature greater than or equal to about 50° C., and wherein the relative rate of addition of the first and second monomer feeds into the reaction zone is continuously changed during at least part of said emulsion polymerization and the rate of addition of the initiator is changed step-wise at least once during the addition of the first and second monomer feeds.

Conveniently, the rate of addition of one of the first and second monomer feeds, preferably the second monomer feed, into the reaction zone is continuously increased and the addition rate of the other monomer feed, preferably the first monomer feed, into the reaction zone is continuously decreased.

In one embodiment, a fraction of the first monomer feed is added to the reaction zone and subsequently polymerized in the presence of an initiator before parallel addition of the remaining first and second monomer feeds.

Generally, each of said first and second monomer feeds is composed predominately of at least one ester of an ethylenically unsaturated carboxylic acid and further comprises at least one of an ethylenically unsaturated carboxylic acid or an anhydride or amide thereof, an ethylenically unsaturated sulfonic acid, or an ethylenically unsaturated phosphonic acid.

Conveniently, at least the first monomer feed comprises at least one ethylenically unsaturated monomer containing at least one keto group or aldehyde group.

In a further aspect, the invention resides in a polymer dispersion comprising particles of a polymer composition formed by emulsion polymerization of at least first and second monomer feeds in parallel in a reaction zone, wherein the first monomer feed comprises at least the following monomers selected to produce a copolymer having a glass transition temperature less than or equal to about −10° C.:

(a) at least one ester of ethylenically unsaturated carboxylic acid;

(b) at least one of an ethylenically unsaturated carboxylic acid or an anhydride or amide thereof, or an ethylenically unsaturated sulfonic acid or an ethylenically unsaturated phosphonic acid; and

(c) at least one ethylenically unsaturated monomer containing at least one keto group or aldehyde group; and

wherein the second monomer feed comprises at least the following monomers selected to produce a copolymer having a glass transition temperature greater than or equal to about 50° C.:

(a) at least one ester of ethylenically unsaturated carboxylic acid whose homopolymer has a glass transition temperature greater than or equal to about 60° C.; and

(b) at least one of an ethylenically unsaturated carboxylic acid or an anhydride or amide thereof, or an ethylenically unsaturated sulfonic acid or an ethylenically unsaturated phosphonic acid.

In yet a further aspect, the invention resides in an emulsion polymerization process for preparing a polymer dispersion comprising simultaneously adding at least first and second monomer feeds to a reaction zone, wherein the first monomer feed comprises at least the following monomers selected to produce a copolymer having a glass transition temperature less than or equal to about −10° C.:

(a) at least one ester of an ethylenically unsaturated carboxylic acid;

(b) at least one of an ethylenically unsaturated carboxylic acid or an anhydride or amide thereof, or an ethylenically unsaturated sulfonic acid or an ethylenically unsaturated phosphonic acid;

(c) at least one ethylenically unsaturated monomer containing at least one keto group or aldehyde group;

wherein the second monomer feed comprises at least the following monomers selected to produce a copolymer having a glass transition temperature greater than or equal to about 50° C.:

(a) at least one ester of ethylenically unsaturated carboxylic acid; and

(b) at least one of an ethylenically unsaturated carboxylic acid or an anhydride or amide thereof, or an ethylenically unsaturated sulfonic acid or an ethylenically unsaturated phosphonic acid; and

wherein the relative rate of addition of the first and second monomer feeds into the reaction zone is continuously changed during at least part of said process.

### DETAILED DESCRIPTION

Described herein are acrylic polymer dispersions produced by emulsion polymerization of at least two different monomer feeds selected to produce polymer particles of optimum morphology and dispersions with a minimum film forming temperature of less than 10° C. Also disclosed are methods of producing the polymer dispersions and use of the dispersions in lacquers, varnishes and high-gloss trim paint formulations.

### Monomer Feeds

The monomer feeds used herein are substantially styrene-free and preferably contain no measurable amount of styrene. In general, other vinyl aromatic monomers should also be avoided.

One monomer feed (the first monomer feed) is composed of monomers which, when polymerized, produce a copolymer having a glass transition temperature (T_{g}) of less than or equal to −10° C., generally from about −20° C. to about −60° C. Another monomer feed (the second monomer feed) is composed of monomers which, when polymerized, produce a copolymer having a glass transition temperature (T_{g}) of greater than or equal to +50° C., generally from about +60° C. to about +107° C. T_{g} can be calculated using the Fox equation. Generally, the first monomer feed contains from about 20 to about 60 weight percent of the total amount of monomers in the first and second feeds and the second monomer feed contains from about 40 to about 80 weight percent of the total amount of monomers in the first and second feeds.

Each of the first and second monomer feeds comprises predominately (a) at least one ester of an ethylenically unsaturated carboxylic acid. Suitable esters (a) include C₂-C₁₈ alkyl esters of ethylenically unsaturated carboxylic acids, such as (meth)acrylic acid, maleic acid and fumaric acid. Examples include ethyl acrylate, n-propyl acrylate, isopropyl acrylate, methyl methacrylate, n-butyl acrylate, 1-hexyl acrylate, and 2-ethylhexyl acrylate. It is preferable, though not required, that the at least one ester of ethylenically unsaturated carboxylic acid make up at least about 80 percent by weight of the first monomer feed and at least about 85 percent by weight of the second monomer feed.

In addition to the main monomer (a), each of the first and second monomer feeds may also include a monomer (b) comprising at least one of an ethylenically unsaturated carboxylic acid or an anhydride or amide thereof, an ethylenically unsaturated sulfonic acid, or an ethylenically unsaturated phosphonic acid.

For example, the monomer (b) may comprise an ethylenically unsaturated C₃-C₈ monocarboxylic acid and/or an ethylenically unsaturated C₄-C₈ dicarboxylic acids, together with the anhydrides or amides thereof. Examples of suitable ethylenically unsaturated C₃-C₈ monocarboxylic acids include acrylic acid, methacrylic acid and crotonic acid. Examples of suitable ethylenically unsaturated C₄-C₈ dicarboxylic acids include maleic acid, fumaric acid, itaconic acid and citraconic acid.

Examples of suitable ethylenically unsaturated sulfonic acids include those having 2-8 carbon atoms, such as vinylsulfonic acid, 2-acrylamido-2-methylpropanesulfonic acid, 2-acryloyloxyethanesulfonic acid and 2-methacryloyloxyethanesulfonic acid, 2-acryloyloxy- and 3-methacryloyloxypropanesulfonic acid. Examples of suitable ethylenically unsaturated phosphonic acids also include those having 2-8 carbon atoms, such as vinylphosphonic acid and ethylenically unsaturated polyethoxyalkyletherphosphates.

In addition to or instead of said acids, it is also possible to use the salts thereof, preferably the alkali metal or ammonium salts thereof, particularly preferably the sodium salts thereof, such as, for example, the sodium salts of vinylsulfonic acid and of 2-acrylamidopropanesulfonic acid.

It is preferable, though not required, that the at least one monomer (b) makes up from about 0.5 percent to about 5 percent by weight of each of the first and second monomer feeds.

The first monomer feed, and in some cases both the first and second monomer feeds, may also contain at least one carbonyl functional co-monomer (c) Such carbonyl functional co-monomers are generally ethylenically unsaturated monomers containing keto groups and/or aldehyde groups. Examples include (meth)acrolein, diacetone acrylamide, vinyl alkyl ketones having 4 to 10 carbon atoms such as vinyl methyl ketone, vinyl ethyl ketone or vinyl butyl ketone, diacetone acrylate, acetonitrile acrylate, diacetone methacrylate, 2-hydroxypropyl acrylate acetyl acetate, butanediol-1,4-acrylate acetyl acetate and acetoacetoxy ethyl methacrylate. A preferred carbonyl functional co-monomer is diacetone acrylamide (DAAM). Generally, the co-monomer (c) makes up from about 1 percent to about 7.5 percent by weight of the first monomer feed and from 0 percent to about 5 percent by weight of the polymer of the second monomer feed.

In one preferred embodiment, co-monomer (c) is predominately added to the first monomer feed as opposed to the second monomer feed. In this manner, it is possible to obtain polymer particles with a heterogeneous distribution of latent crosslinking functionality.

In addition, each of the first and second monomer feeds may contain up to 10 weight % of other ethylenically unsaturated monomers, which are co-polymerizable with monomers (a) to (c). Such optional co-monomers can be those which promote better film or coating performance by the compositions herein or can provide films and coatings of desirable properties. Such desirable film/coating properties can include, for example, enhanced adhesion to surfaces or substrates, improved wet adhesion, better resistance to removal by scrubbing or other types of weathering or abrasion, and improved resistance to film or coating cracking. The optional co-monomers useful for incorporation into the emulsion copolymers of the compositions herein are those which contain at least one polymerizable double bond along with one or more additional functional moieties. Such optional or auxiliary co-monomers can thus include unsaturated silane co-monomers, glycidyl co-monomers, ureido co-monomers and combinations of these auxiliary optional co-monomers.

Unsaturated silanes useful as optional co-monomers can generally correspond to a substituted silane of the structural Formula I:

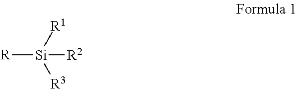

in which R denotes an organic radical olefinically unsaturated in the ω-position and R¹R² and R³ which may be identical or different, denote the group —OZ, Z denoting hydrogen or primary or secondary alkyl or acyl radicals optionally substituted by alkoxy groups. Suitable unsaturated silane compounds of the Formula I are preferably those in which the radical R in the formula represents an ω-unsaturated alkenyl of 2 to 10 carbon atoms, particularly of 2 to 4 carbon atoms, or an ω-unsaturated carboxylic acid ester formed from unsaturated carboxylic acids of up to 4 carbon atoms and alcohols carrying the Si group of up to 6 carbon atoms. Suitable radicals R¹, R², R³ are preferably the group —OZ, Z representing primary and/or secondary alkyl radicals of up to 10 carbon atoms, preferably up to 4 carbon atoms, or alkyl radicals substituted by alkoxy groups, preferably of up to 3 carbon atoms, or acyl radicals of up to 6 carbon atoms, preferably of up to 3 carbon atoms, or hydrogen. Most preferred unsaturated silane co-monomers are vinyl trialkoxy silanes.

Examples of preferred silane compounds of the Formula I include γ-methacryloxypropyltris(2-methoxyethoxy)silane, vinylmethoxysilane, vinyltriethoxysilane, vinyldiethoxysilanol, vinylethoxysilanediol, allyltriethoxysilane, vinyltripropoxysilane, vinyltriisopropoxysilane, vinyltributoxysilane, vinyltriacetoxysilane, trimethylglycolvinylsilane, γ-methacryloxypropyltrimethylglycolsilane, γ-acryloxypropyltriethoxysilane and γ-methacryloxypropyltrimethoxysilane.

Glycidyl compounds can also be used as optional auxiliary co-monomers to impart epoxy-functionality to the emulsion copolymer. Examples of suitable glycidyl optional co-monomers include glycidyl acrylate, glycidyl methacrylate, allyl glycidyl ether, and vinyl glycidyl ether.

Another type of optional co-monomer comprises cyclic ureido co-monomers. Cyclic ureido co-monomers are known to impart improved wet adhesion properties to films and coatings formed from copolymers containing these co-monomers. Cyclic ureido compounds and their use as wet adhesion promoting co-monomers are disclosed in U.S. Pat. Nos. 4,104,220; 4,111,877; 4,219,454; 4,319,032; 4,599,417 and 5,208,285. The disclosures of all of these U.S. patents are incorporated herein by reference in their entirety.

### Preparation of the Polymer Dispersion

The desired polymer dispersion is produced by simultaneous free radical emulsion polymerization of the first and second monomer feeds in an aqueous medium and in the presence of a free radical initiator. Suitable free radical initiators include hydrogen peroxide, benzoyl peroxide, cyclohexanone peroxide, isopropyl cumyl hydroperoxide, persulfates of potassium, of sodium and of ammonium, peroxides of saturated monobasic aliphatic carboxylic acids having an even number of carbon atoms and a C8-C12 chain length, tert-butyl hydroperoxide, di-tert-butyl peroxide, diisopropyl percarbonate, azoisobutyronitrile, acetylcyclohexanesulfonyl peroxide, tert-butyl perbenzoate, tert-butyl peroctanoate, bis(3,5,5-trimethyl)hexanoyl peroxide, tert-butyl perpivalate, hydroperoxypinane, p-methane hydroperoxide. The abovementioned compounds can also be used within redox systems, using transition metal salts, such as iron(II) salts, or other reducing agents. Alkali metal salts of oxymethanesulfinic acid, hydroxylamine salts, sodium dialkyldithiocarbamate, sodium bisulfite, ammonium bisulfite, sodium dithionite, diisopropyl xanthogen disulfide, ascorbic acid, tartaric acid, and isoascorbic acid can also be used as reducing agents.

However, water-soluble persulfates, in particular ammonium persulfate or sodium persulfate, are preferably used for initiating polymerization.

The emulsion polymerization is conducted so that the relative rate of addition of the simultaneously added first and second monomer feeds into the reaction zone is continuously changed during at least part of the polymerization and the rate of addition of the initiator is changed step-wise at least once during the addition of the first and second monomer feeds. In one embodiment, the rate of addition of one of the first and second monomer feeds into the reaction zone is continuously increased during at least part of the polymerization, while at the same time the addition rate of the other monomer feed into the reaction zone is continuously decreased. Preferably, the addition rate of the second monomer feed into the reaction zone is continuously increased and the addition rate of the first monomer feed into the reaction zone is continuously decreased during at least part of the polymerization. In this way, the polymer particles in the dispersion have a gradual change in composition within the particles, together with a heterogeneous molecular weight distribution.

Although the relative rate of addition of the first and second monomer feeds into the reaction zone can be continuously changed throughout the entire polymerization process, in one embodiment an initial polymerization stage is conducted in which a fixed amount of one or both of the first and second monomer feeds is polymerized in the presence of an initiator to produce seed particles. The remainder of the copolymer with the gradient composition and heterogeneous molecular weight distribution is then produced on the seed particles.

Utilizing simultaneously added feeds of different monomers at different addition rates can lead to gradient polymer morphology or a polymer with a continually changing monomeric compositional content. One aspect of the invention involves the preparation of polymer particles with a gradient in polymer composition within the particles.

The polymerized particles typically have an average diameter of less than 150 nm.

The emulsion polymerization is generally carried out in the presence of a stabilization system which comprises one or more anionic and/or nonionic surfactants as emulsifiers. Such emulsifiers are conventional and well known. Suitable nonionic surfactants which can be used as emulsifiers in the emulsion stabilizing system of the copolymer and coating compositions herein include polyoxyethylene condensates. A wide variety of nonionic surfactants of this type are disclosed in the hereinbefore-referenced U.S. Pat. No. 5,849,389.

Even though polyoxyethylene condensates can be used as nonionic emulsifiers in the preparation of the copolymer emulsions and coating compositions herein, the emulsions and compositions herein are preferably substantially free of alkyl phenol ethoxylates (APE) such as octyl phenol ethoxylates. These represent a class of compounds typically used as surfactants that degrade to phenols. Such compounds are of environmental concern due to their estrogen mimicking characteristics.

Suitable anionic surfactants which can be used as emulsifiers in the emulsion stabilizing system of the emulsion copolymer and coating compositions herein include alkyl aryl sulfonates, alkali metal alkyl sulfates, sulfonated alkyl esters and fatty acid soaps. A wide variety of anionic surfactants of this type are also disclosed in the hereinbefore-referenced U.S. Pat. No. 5,849,389.

Conventionally, various protective colloids such as carboxymethyl cellulose (CMC) and other conventional protective colloid-forming materials have also been used to stabilize emulsion polymer latex compositions of the types hereinbefore described, instead of or in addition to the surfactant emulsifiers. In one embodiment, the emulsions and compositions herein can contain up to about 5 wt % of protective colloid stabilizing agents, based on the total amount of copolymers in the emulsions or compositions being stabilized. Preferably there are no protective colloids.

In another embodiment, the emulsions and compositions herein can be substantially free of such protective colloids as stabilizing agents. Such emulsions are considered to be “substantially free” of protective colloids if protective colloids comprise no more than 0.5 wt % of the emulsions and compositions, based on the total amount of copolymers in the emulsions or compositions being stabilized. The latex emulsions and compositions herein which utilize emulsifier, i.e., surfactant, stabilizing agents and are substantially free of protective colloids are characterized herein as being “substantially all-surfactant-based” emulsions and compositions.

In addition to monomers described herein, the final polymers may also contain a selected type of water-soluble cross-linking agent. Such a cross-linking agent will react with the carbonyl functionalities of the polymer as water is removed from the coating compositions herein and as a film or coating is formed from the polymerized components.

A type of water-soluble cross-linking agent that can be used in the compositions herein comprises a compound which contains at least two hydrazine and/or hydrazide moieties. Particularly suitable are dihydrazine compounds of aliphatic dicarboxylic acids of 2 to 10, in particular 4 to 6, carbon atoms, e.g., oxalic acid dihydrazide, malonic acid dihydrazide, succinic acid dihydrazide, glutaric acid dihydrazide, adipic acid dihydrazide, sebacic acid dihydrazide, maleic acid dihydrazide, fumaric acid dihydrazide and/or itaconic acid dihydrazide. Water-soluble aliphatic dihydrazines of 2 to 4 carbon atoms, e.g., ethylene-1,2-dihydrazine, propylene-1,3-dihydrazine or butylene-1,4-dihydrazine, are also suitable. Adipic acid dihydrazide (ADH) is a preferred water-soluble cross-linking agent for use in the compositions herein.

Generally, such water-soluble cross-linking agents are post added to the dispersion such that the molar ratio of cross-linking agent hydrazine groups to carbonyl groups in the polymer is between about 0.1 and about 2.0. More preferably the molar ratio of cross-linking agent hydrazine groups to copolymer carbonyl groups in the blend will be between about 0.5 and 2.0.

After polymerization the dispersion is typically neutralized to alkaline pH. This can be accomplished by, for example, the addition of potassium hydroxide. In one embodiment, after polymerization a dilute solution of potassium hydroxide is added to the reaction vessel together with non-ionic surfactant to avoid ionic shock and obtain a coagulum-free dispersion. Such a method results in an ammonia-free product, which is one of the objectives of the invention.

### Coating/Paint Composition Formulation and Preparation

The aqueous polymer dispersions described herein are stable fluid systems which can be used to produce coating compositions suitable for use as high gloss trim paints, lacquers and varnishes. When used in paint applications, the aqueous polymer dispersions are typically combined with one or more conventional fillers and/or pigments. In this context, pigments are understood as meaning solids which have a refractive index greater than or equal to 1.75, whereas fillers are understood as meaning solids which have a refractive index of less than 1.75.

Preferred fillers useful in the paint compositions herein can be, for example, calcium carbonate, magnesite, dolomite, kaolin, mica, talc, silica, calcium sulfate, feldspar, barium sulfate and opaque polymer. Examples of white pigments useful in the paint compositions herein can be zinc oxide, zinc sulfide, basic lead carbonate, antimony trioxide, lithopone (zinc sulfide+barium sulfate) and, preferably, titanium dioxide. Examples of inorganic colored pigments which may preferably be used in the paint compositions herein include iron oxides, carbon black, graphite, luminescent pigments, zinc yellow, zinc green, Paris blue, ultramarine, manganese black, antimony black, manganese violet or Schweinfurt green. Suitable organic colored pigments preferably are, for example, sepia, gamboge, Cassel brown, toluidine red, para red, Hansa yellow, indigo, azo dyes, anthraquinone and indigo dyes as well as dioxazine, quinacridone, phthalocyanin, isoindolinone and metal complex pigments of the azomethine series.

The fillers may be used as individual components. Mixtures of fillers such as, for example, calcium carbonate/kaolin and calcium carbonate/kaolin/talc have also been found to be particularly useful in practice. To increase the hiding power of the coating and to save on titanium dioxide, finely divided fillers such as, for example, finely divided calcium carbonate and mixtures of various calcium carbonates with different particle size distribution are frequently used. Calcined clays are commonly used to increase film dry opacity as they help incorporate air voids into the dry film. Air voids create a big difference in refractive index in the film and scatter light, yielding more opacity in the film once cured. To adjust the hiding power, the shade and the depth of color of the coatings formed, the fillers are mixed with appropriate amounts of white pigment and inorganic and/or organic colored pigments.

To disperse the fillers and pigments in water, auxiliaries based on anionic or non-ionic wetting agents, such as preferably, for example, sodium pyrophosphate, sodium polyphosphate, naphthalenesulfonate, sodium polyacrylate, sodium polymaleinates and polyphosphonates such as sodium 1-hydroxyethane-1,1-diphosphonate and sodium nitrilotris(methylenephosphonate), may be added.

Thickeners may also be added to the paint formulations herein. Thickeners which may be used include, inter alia, sodium polyacrylate and water-soluble copolymers based on acrylic and methacrylic acid, such as acrylic acid/acrylamide and methacrylic acid/acrylic ester copolymers. Hydrophobically-modified alkali soluble (acrylic) emulsions (HASE), hydrophobically-modified ethoxylate (poly)urethanes (HEUR), and polyether polyols (PEPO) are also available. Inorganic thickeners, such as, for example, bentonites or hectorite, may also be used.

For various applications, it is sometimes also desirable to include small amounts of other additives, such as biocides, pH modifiers, and antifoamers, incorporated in the latex paint compositions herein. This may be done in a conventional manner and at any convenient point in the preparation of the latexes.

Commercially available coalescent agent free high gloss trim paints may contain other components which serve to raise the Volatile Organic Content of the paint formulation. Volatile Organic Content means any organic compound having an initial boiling point less than or equal to 250° C. measured at a standard pressure of 101.3 kPa. Preferably the coating composition also do not contain any Semi-Volatile Organic Content SVOC which have usually a boiling point higher than 250° C. VOC sources may include co-solvents, including glycols, which help with wet edge application, open time, and freeze-thaw resistance, emulsion components and most additives at low levels. For instance, amino methyl propanol is a volatile compound used to adjust pH.

Volatile Organic Content in terms of grams per liter is calculated according to the formula set forth in the hereinbefore-mentioned Directive 2004/42/CE of the European Parliament and The Council of The European Union. Commercially available trim paints may have VOC levels higher than 130 g/L. In contrast, the polymer dispersion described herein can have a very low volatile organic content (VOC), such as less than 1 g/L.

### Coating/Paint Composition Performance

When used in a trim paint, the polymer dispersion described herein forms a film or coating which, upon curing, will adhere to a substrate onto which the trim paint has been applied. The trim paint seals and protects the substrate.

The minimum temperature required for the polymer dispersion to form a film is referred to as the Minimum Film-Forming Temperature or MFFT (DIN ISO 2115) MFFT is related to the glass transition temperature, T_{g}, of the polymer dispersion. The trim paint herein will preferably have a MFFT of equal to or less than about 10° C., more preferably equal to or less than about 5° C.

Trim paint employing the polymer dispersion described herein will form films or coatings which exhibit excellent adhesion onto dry substrates or hard surfaces to which such compositions have been applied. The coatings so formed will also exhibit excellent wet adhesion characteristics. Wet adhesion refers to the ability of the coating to adhere to a substrate under wet conditions. Wet adhesion is a critical property not only for exterior trim paints, but also for some interior applications, such as in kitchens and bathrooms.

The wet adhesion and dry adhesion performance of trim paints be quantified by means of testing in accordance with ASTM Test No. D 3359-02.

As noted above, another important performance property of trim paints relates to blocking resistance. Blocking refers to the relative tackiness of a dry coating. It is desirable that two dry, coated surfaces when placed in contact do not block or stick together. The poylmer dispersion herein, with their selected monomers along with the selected type of cross-linking system, exhibit excellent resistance to blocking of the high gloss trim paint.

Addition of fluorocarbon surfactants can also serve to improve block resistance even further by modifying surface properties. A fluorocarbon surfactant acts as a surface-active agent that blooms to the top of a film (the air interface) as it dries or cures and acts as a release layer that interferes with the intermingling of resin layers of two films in contact with one another.

Fluorocarbon surfactant additives of this class may be obtained from DuPont™ under the designation Capstone™ or Zonyl®, or 3M™ under the designation Novec™, for example. See “DuPont™ Zonyl® Fluoroadditives as Antiblock Agents, A Comparative Study”, Product Literature, January 2003. See also, United States Patent Application 2008/0145552 to Berrettini et al. which provides examples of suitable fluoroadditives. See also U.S. Pat. No. 7,041,727 to Kubicek et al.

The invention will now be more particularly described with reference to the following non-limiting Examples.

### EXAMPLE 1

A 3 liter reactor equipped with a condenser and anchor stirrer was filled with 636.1 g of water and 33.3 g of a sodium alkyl ether sulfate (28%, 7 ethylene oxide units). The reactor content was heated to 80° C. and 4.6% of Feed 1 as described in Table 1 was added. A solution of 0.66 g sodium persulfate in 15.5 g of water was added and the reactor contents were held at 80° C. for 15 minutes. The remaining part of Feed 1, Feed 2 and Feed 3 were added in parallel over 210 minutes as follows:
the feed rate of the remaining part of Feed 1 was linearly decreased from 6.27 g/min to 1.50 g/min over the feed time;
the feed rate of Feed 2 was linearly increased from 1.70 g/min to 6.50 g/min over the feed time;
the feed rate of Feed 3 was 0.18 g/min during the first 105 minutes of the feed time and 0.37 g/min during the last 105 minutes of the feed time.

The reactor temperature during the feeds was maintained at 80° C. After completion of the feeds, the reactor content was held at 80° C. for another 60 minutes and then cooled to room temperature. A mixture of 151.3 g potassium hydroxide (5%) and 5.0 g of an oxoalkyl ethoxylate (70%, 28 ethylene oxide units) was added over 15 minutes, followed by 115.8 g of adipic acid dihydrazide (10%) and biocide solutions.

The resulting polymer dispersion had the properties summarized in Table 3.

### EXAMPLE 2

A 3 liter reactor equipped with a condenser and anchor stirrer was filled with 636.1 g of water and 33.3 g of a sodium alkyl ether sulfate (28%, 7 ethylene oxide units). The reactor content was heated to 80° C. and 4.6% of Feed 1 as described in Table 1 was added. A solution of 0.66 g sodium persulfate in 15.5 g of water was added and the reactor contents were held at 80° C. for 15 minutes. The remaining part of Feed 1, Feed 2 and Feed 3 were added in parallel over 210 minutes as follows:
the feed rate of the remaining part of Feed 1 was linearly decreased from 6.33 g/min to 1.50 g/min over the feed time;
the feed rate of Feed 2 was linearly increased from 1.60 g/min to 6.55 g/min over the feed time;
the feed rate of Feed 3 was 0.37 g/min during the first 105 minutes of the feed time and 0.18 g/min during the last 105 minutes of the feed time.

The reactor temperature during the feeds was maintained at 80° C. After completion of the feeds, the reactor content was held at 80° C. for another 60 minutes and then cooled to room temperature. A mixture of 151.3 g potassium hydroxide (5%) and 5.0 g of an oxoalkyl ethoxylate (70%, 28 ethylene oxide units) was added over 15 minutes, followed by 115.8 g of adipic acid dihydrazide (10%) and biocide solutions.

The resulting polymer dispersion had the properties summarized in Table 3.

### EXAMPLE 3 (COMPARATIVE)

A 3 liter reactor equipped with a condenser and anchor stirrer was filled with 636.1 g of water and 33.3 g of a sodium alkyl ether sulfate (28%, 7 ethylene oxide units). The reactor content was heated to 80° C. and 4.6% of Feed 1 as described in Table 1 was added. A solution of 0.66 g sodium persulfate in 15.5 g of water was added and the reactor contents were held at 80° C. for 15 minutes.

The remaining part of Feed 1 was added to the reactor over 103 minutes at constant feed rate, immediately followed by the addition of Feed 2 over 107 minutes at constant feed rate. The feed rate of Feed 3 was 0.37 g/min during the first 105 minutes of the feed time and 0.18 g/min during the last 105 minutes of the feed time.

The reactor temperature during the feeds was maintained at 80° C. After completion of the feeds, the reactor content was held at 80° C. for another 60 minutes and then cooled to room temperature. A mixture of 151.3 g potassium hydroxide (5%) and 5.0 g of an oxoalkyl ethoxylate (70%, 28 ethylene oxide units) was added over 15 minutes, followed by 115.8 g of adipic acid dihydrazide (10%) and biocide solutions.

The resulting polymer dispersion had the properties summarized in Table 3.

TABLE 1

| | | Example 1 | Example 2 | Example 3 |
|---|---|---|---|---|
| Feed 1 | | | | |
| Water | [g] | 235.1 | 230.4 | 230.4 |
| Sodium alkyl ether sulfate (28%, | [g] | 21.0 | 20.6 | 20.6 |
| 7 ethylene oxide units) | | | | |
| Methacrylic Acid | [g] | 3.9 | 11.5 | 11.5 |
| Acrylic Acid | [g] | 1.9 | 5.8 | 5.8 |
| Diacetone Acrylamide | [g] | 5.9 | 17.3 | 17.3 |
| Methyl Methacrylate | [g] | 528.9 | 28.8 | 28.8 |
| Butyl Acrylate | [g] | 58.8 | 547.2 | 547.2 |
| Feed 2 | | | | |
| Water | [g] | 230.4 | 235.1 | 235.1 |
| Sodium alkyl ether sulfate (28%, | [g] | 20.6 | 21.0 | 21.0 |
| 7 ethylene oxide units) | | | | |
| Methacrylic Acid | [g] | 11.5 | 3.9 | 3.9 |
| Acrylic Acid | [g] | 5.8 | 1.9 | 1.9 |
| Diacetone Acrylamide | [g] | 17.3 | 5.9 | 5.9 |
| Methyl Methacrylate | [g] | 28.8 | 528.9 | 528.9 |
| Butyl Acrylate | [g] | 547.2 | 58.8 | 58.8 |
| Feed 3 | | | | |
| Water | [g] | 53.7 | 53.7 | 53.7 |
| Sodium Persulfate | [g] | 3.9 | 3.9 | 3.9 |

### EXAMPLE 4

### Preparation of a High Gloss Paint

High gloss paints were prepared by mixing the ingredients shown in Table 2 at room temperature under stirring:

TABLE 2

| | Parts by weight |
|---|---|
| Grind: | |
| Water | 75 |
| Polymeric dispersing agent (Lopon 890) | 8 |
| Sodium Polyacrylate thickener (Mowilith LDM 7002) | 30 |
| Defoamer based on polysiloxane (Byk 044) | 2 |
| Preservative (Mergal K 10 N) | 2 |
| NaOH (10%) | 15 |
| Aminomethylpropanol | 2 |
| Titanium dioxide (Tronox CR 828) | 210 |
| Let down: | |
| Polymer composition as per Example 1, 2, or 3 | 622 |
| Wax emulsion (Sudranol 240) | 20 |
| Water | 14 |

Characteristics: Solids content ca. 50.6%;
Pigment ratios: Dispersion:pigment/filler mixture ca. 1:0.35
Binder solids: pigment/filler mixture ca. 1:0.77
Pigment volume concentration (p.v.c.) ca. 17
Specific weight at 23° C. ca. 1.2 kg/L

The resultant paints had the properties summarized in Table 3.

TABLE 3

| | | Viscosity | | | | |
|---|---|---|---|---|---|---|
| | | (Brookfield) | | | | Block- |
| | Solids | mPa · s (23° | | | Elast- | ing |
| | Content | C., 20 rpm, | | MFFT | icity | (g/6.25 |
| | (%) | spindle1) | pH | (° C.)¹ | (%)² | cm2)³ |
| Example 1 | 45 | 63 | 8.3 | 2 | 80 | 1690 |
| Example 2 | 45 | 180 | 8.0 | 4 | 117 | 2000 |
| Example 3 | 45 | 194 | 8.22 | 0 | 4 | 2340 |

¹MFFT according DIN ISO 2115.
²300 mn emulsion paint applied to PE film and measured after 7 days.
³To test blocking resistance, microscope slides (76*26*1 mm) from Marienfeld were coated in a wet-film thickness of 200 μm.
After drying at 1 day for 24 hours, two coated microscope slides were placed with their coated sides together and were subjected at 50° C. for 1 hour to a force of 2 kg.
Subsequently the force required to separate the microscope slides was determined.

1. A polymer dispersion comprising particles of a polymer composition formed at least partially by emulsion polymerization of at least first and second, simultaneously added, substantially styrene-free monomer feeds in the presence of an initiator in a reaction zone, wherein the first monomer feed comprises monomers selected to produce a copolymer having a glass transition temperature less than or equal to about −10° C. and the second monomer feed comprises monomers selected to produce a copolymer having a glass transition temperature greater than or equal to about 50° C., and wherein the relative rate of addition of the first and second monomer feeds into the reaction zone is continuously changed during at least part of said emulsion polymerization and the rate of addition of the initiator is changed step-wise at least once during the addition of the first and second monomer feeds.

2. A polymer dispersion according to claim 1, wherein the rate of addition of one of the first and second monomer feeds into the reaction zone is continuously increased and the addition rate of the other monomer feed into the reaction zone is continuously decreased.

3. A polymer dispersion according to claim 2, wherein the addition rate of the second monomer feed into the reaction zone is continuously increased and the addition rate of the first monomer feed into the reaction zone is continuously decreased.

4. A polymer dispersion according to claim 1, wherein the particles of the polymer composition are partially formed by emulsion polymerization of the first and/or the second monomer feed in the presence of an initiator in the reaction zone.

5. A polymer dispersion to claim 1, wherein the particles of the polymer composition have an average diameter of less than 150 nm

6. A polymer dispersion according to claim 1, wherein each of said first and second monomer feeds is composed predominately of at least one ester of an ethylenically unsaturated carboxylic acid.

7. A polymer dispersion according to claim 6, wherein each of said first and second monomer feeds further comprises at least one of an ethylenically unsaturated carboxylic acid or an anhydride or amide thereof, an ethylenically unsaturated sulfonic acid, or an ethylenically unsaturated phosphonic acid.

8. A polymer dispersion according to claim 6, wherein at least the first monomer feed further comprises at least one ethylenically unsaturated monomer containing at least one keto group or aldehyde group.

9. A polymer dispersion comprising particles of a polymer composition formed by emulsion polymerization of at least first and second simultaneously added monomer feeds in a reaction zone, wherein the first monomer feed comprises at least the following monomers selected to produce a copolymer having a glass transition temperature less than or equal to about −10° C.:
(a) at least one ester of ethylenically unsaturated carboxylic acid;
(b) at least one of an ethylenically unsaturated carboxylic acid or an anhydride or amide thereof, or an ethylenically unsaturated sulfonic acid or an ethylenically unsaturated phosphonic acid; and
(c) at least one ethylenically unsaturated monomer containing at least one keto group or aldehyde group; and
wherein the second monomer feed comprises at least the following monomers selected to produce a copolymer having a glass transition temperature greater than or equal to about 50° C.:
(a) at least one ester of ethylenically unsaturated carboxylic acid whose homopolymer has a glass transition temperature greater than or equal to about 60° C.; and
(b) at least one of an ethylenically unsaturated carboxylic acid or an anhydride or amide thereof, or an ethylenically unsaturated sulfonic acid or an ethylenically unsaturated phosphonic acid.

10. A polymer dispersion according to claim 9, wherein the addition rate of one of the at least two monomer feeds into the reaction zone is continuously increased and the addition rate of the other monomer feed into the reaction zone is continuously decreased.

11. A polymer dispersion according to claim 9, wherein the first monomer feed contains from about 20 to about 60 weight percent of the total amount of monomers in the first and second feeds and the second monomer feed contains from about 40 to about 80 weight percent of the total amount of monomers in the first and second feeds.

12. A polymer dispersion according to claim 9, wherein the first monomer feed comprises:
(a) at least 80 weight percent of at least one ester of an ethylenically unsaturated carboxylic acid;
(b) from about 0.5 weight percent to about 5 weight percent of at least one of an ethylenically unsaturated carboxylic acid or an anhydride or amide thereof, or an ethylenically unsaturated sulfonic acid or an ethylenically unsaturated phosphonic acid; and
(c) from about 1 weight percent to about 7.5 weight percent of at least one ethylenically unsaturated monomer containing at least one keto group or aldehyde group;
and wherein the second monomer feed comprises:
(a) at least 85 weight percent of at least one ester of ethylenically unsaturated carboxylic acid whose homopolymer has a glass transition temperature greater than or equal to about 60° C.; and
(b) from about 0.5 weight percent to about 5 weight percent of at least one of an ethylenically unsaturated carboxylic acid or an anhydride or amide thereof, or an ethylenically unsaturated sulfonic acid or an ethylenically unsaturated phosphonic acid.

13. A polymer dispersion according to claim 9, wherein the amount of polymer from the second monomer feed relative to the amount of polymer from the first monomer feed changes within the particles of the polymer composition.

14. A polymer dispersion according to claim 13 wherein the molecular weight distribution of the polymer composition is heterogeneous within the polymer particles.

15. A polymer dispersion according to claim 9, wherein the polymer dispersion further comprises at least one polyfunctional carboxylic hydrazide.

16. A polymer dispersion according to claim 9, having a volatile organic compounds content of less than 500 ppm.

17. An emulsion polymerization process for preparing a polymer dispersion comprising simultaneously adding at least first and second monomer feeds to a reaction zone, wherein the first monomer feed comprises at least the following monomers selected to produce a copolymer having a glass transition temperature less than or equal to about −10° C.:
(a) at least one ester of an ethylenically unsaturated carboxylic acid;
(b) at least one of an ethylenically unsaturated carboxylic acid or an anhydride or amide thereof, or an ethylenically unsaturated sulfonic acid or an ethylenically unsaturated phosphonic acid;
(c) at least one ethylenically unsaturated monomer containing at least one keto group or aldehyde group; and
wherein the second monomer feed comprises at least the following monomers selected to produce a copolymer having a glass transition temperature greater than or equal to about 50° C.:
(a) at least one ester of ethylenically unsaturated carboxylic acid; and
(b) at least one of an ethylenically unsaturated carboxylic acid or an anhydride or amide thereof, or an ethylenically unsaturated sulfonic acid or an ethylenically unsaturated phosphonic acid; and
wherein the relative rate of addition of the first and second monomer feeds to the reaction zone is continuously changed during at least part of said process.

18. A process according to claim 17, wherein an initiator is added to the reaction zone simultaneously with the first and second monomer feeds and wherein the rate of the initiator addition is changed step-wise at least once during the course of addition.

19. The process according to claim 18, wherein the rate of addition of the initiator rate is step-wise lowered during the course of addition.

20. The process according to claim 17, wherein a fraction of the total monomer feed is polymerized in the reaction zone prior to the simultaneous addition of the remaining monomer feeds into the reaction zone.

21. The process according to claim 17, wherein the polymer dispersion is neutralized with a solution selected from the group consisting of a solution of an alkali metal hydroxide, a solution of an alkaline earth metal hydroxide, and a solution of an alkali metal hydroxide or an alkaline earth metal hydroxide and a surfactant.

22. A coating composition comprising the polymer dispersion of claim 1.

23. A coating composition according to claim 22 and having a minimum film forming temperature (MFFT) below 10° C.

24. A lacquer comprising the coating composition according to claim 22.

25. A high-gloss trim paint formulation comprising the coating composition according to claim 22.

26. A vanish comprising the coating composition according to claim 22.
